(19) United States
(12) Patent Application Publication
(10) Pub. No.: US 2011/0265300 A1
(43) Pub. Date: Nov. 3, 2011

(54) DEVICE FOR TEMPORARILY FIXING IN POSITION TWO FUSELAGE SECTIONS TO BE JOINED

(76) Inventors: Rolf Bense, Jork (DE); Dirk Bausen, Hareefeld (DE); Axel Sauermann, Delnste-Helmste (DE)

(21) Appl. No.: 13/101,714

(22) Filed: May 5, 2011

Related U.S. Application Data
(63) Continuation of application No. PCT/EP2009/064281, filed on Oct. 29, 2009.
(60) Provisional application No. 61/111,590, filed on Nov. 5, 2008.

(30) Foreign Application Priority Data
Nov. 5, 2008 (DE) 10 2008 043 490.6

(51) Int. Cl. B25B 11/02

(52) U.S. Cl. 29/283

(57) ABSTRACT

A device for positional fixation of a first fuselage section to be joined onto a second one in a butt-join region, the first fuselage section being planked with a first skin and the second fuselage section being planked with a second skin. The fuselage sections are temporary connectable by at least one clamping element in the butt-join region for carrying out a joining process. The clamping elements are each formed with a holder and a counter holder, wherein for example the holders are positioned exteriorly on the second skin while the counter holders are positioned interiorly on an interior side of the first skin opposite in the butt-join region. Each holder comprises at least one magnet for temporarily fixing the fuselage sections to one another and preventing intrusion of bore chips in-between the skins and/or, as the case may be, a butt-join strap by use of the magnetic force of attraction toward the counter holder.

### CROSS-REFERENCE TO RELATED APPLICATIONS

This application is a continuation of and claims priority to PCT International Application No. PCT/EP2009/064281 filed Oct. 29, 2009, which claims the benefit of and priority to U.S. Provisional Application No. 61/111,590, filed Nov. 5, 2008 and German Patent Application No. 10 2008 043 490.6, filed Nov. 5, 2008, the entire disclosures of which are herein incorporated by reference.

### FIELD OF THE INVENTION

The invention relates to a device for fixing in position a first fuselage section in a transverse joint region and a second fuselage section to be joined, the first fuselage section being planked with a first skin and the second fuselage section being planked with a second skin.

In modern aircraft construction, sectional construction is used as standard in the integration of aircraft fuselages. In this context, a plurality of fuselage sections are joined along transverse seams to form the fuselage cell of the aircraft. The fuselage sections are in turn produced with at least two shell segments to form longitudinal seams. On the inner face, the fuselage sections have annular formers which are arranged in succession and which are planked on the outer face with the fuselage cell skin. For further reinforcement of the fuselage cell structure and in particular of the fuselage cell skin, a plurality of longitudinal reinforcement profiles extend in the longitudinal direction of the fuselage section, parallel, mutually spaced, and distributed around the periphery of the fuselage section.

The fuselage sections are preferably interconnected in the transverse joint region by rivet or bolt connections. A plurality of holes therefore have to be made in the transverse joint region of the fuselage sections to be joined for introducing the rivets and bolts.

In the conventionally used method, the fuselage sections are initially orientated relative to one another. Subsequently, approximately 20% of the total number of holes required to produce the complete connection are made in the transverse joint region of the fuselage section using drilling templates. Subsequently, the fuselage sections have to be separated again so as completely to remove any drilling chips that may be present from the transverse joint region. Subsequently, the fuselage sections are again orientated in relation to one another, and temporary fixing means are inserted in further holes made for fixing the fuselage sections in position. Subsequently, the fastening means, for example rivets or bolts, are introduced into the holes, and the fuselage sections are thus connected in the transverse joint region. Subsequently, the temporary fixing means can be removed and the eventual fastening means, such as rivets or bolts, can be inserted into the cleared holes and tightened. To produce a complete transverse seam between two fuselage sections of an aircraft fuselage cell, several thousand holes generally have to be made and a corresponding number of connecting members introduced into them.

The main drawback of this approach is that the fuselage sections to be joined have to be orientated or positioned relative to one another twice so as to remove the drilling chips which inevitably result from making the preliminary holes in the transverse joint region. This leads to an unnecessarily high manufacturing cost. Moreover, carrying out the orientation process twice reduces the precision of manufacture.

### SUMMARY OF THE INVENTION

The object of the invention is therefore to provide a device by means of which two fuselage sections to be joined can be temporarily fixed in position relative to one another without it being necessary to make (preliminary) holes in the transverse joint region, it consequently not being necessary to separate the fuselage sections again to remove drilling chips.

This object is achieved by a device having the features of claim 1.

Because the fuselage sections can be connected temporarily by at least one gripping member in the transverse joint region,

it is no longer necessary to introduce (fixing) holes for fastening temporary fixing members, in particular in the form of what are known as temporary screw rivets or screw press rivets. The work-intensive reseparation of the fuselage sections, to remove drilling chips resulting from making the fixing holes in the transverse joint region, is omitted.

An advantageous development of the device provides that a plurality of gripping members are provided, and can be positioned on the periphery in the transverse joint region, in particular evenly mutually spaced.

This provides largely distortion-free fixing in position of the fuselage sections to be joined.

Alternatively, the device for fixing in position may, for example, also only comprise one gripping member. In this case, the one gripping member is for example arranged in a “12 o'clock position” or at 0°, in such a way that the first connecting holes can be made in this region. Subsequently, the gripping member is circularly offset in appropriate angular steps of between for example 15° and 90° (what is known as a step-back method) in such a way that the further holes and connecting members can also be introduced into the adjacent peripheral regions of the transverse joint. A device of this type does have lower manufacturing and construction costs, but requires a plurality of manufacturing steps to complete the transverse joint.

In an advantageous configuration, it is provided that the gripping members each comprise a support and a counter support.

Because of the two-part construction of the gripping members, they can be arranged in the transverse joint region even when the fuselage sections are brought together, opposing one another in the inner region and the outer region in each case. Respective, in particular optical markings, with which exact positioning of the support and counter support is possible, are preferably made in the inner region and the outer region of the fuselage sections to be joined. For example, the support of a gripping member may be arranged in the outer region and the counter support of the gripping member may be arranged in the inner region on the fuselage cell skin or on a transverse joint strap in the transverse joint region or in the transverse seam region, said strap being required on the inside in the case of a joint connection of the fuselage cell skins. Alternatively, a reversed arrangement of the support and counter support is possible with respect to the internal and external space of the fuselage sections to be joined. The interaction between the at least one support and the at least one counter support may for example be provided by an electromagnetic field.

In a further advantageous development, it is provided that the at least one support comprises at least one support guide hole and the at least one counter support comprises at least one counter support guide hole for exactly determining the position of holes to be made in the transverse joint region.

This makes it easier to guide a drill to make the fastening holes for the connecting members, such as rivets or bolts. Moreover, this prevents drilling chips from falling out in an uncontrolled manner into the internal region of the fuselage sections to be joined. The support guide holes or the counter support guide holes may optionally be formed as blind holes. In this way, as well as the gripping and fixing effect thereof, the device also provides the effect of a drilling template for precise positioning of the required holes in the transverse joint region.

In a further advantageous embodiment, the support guide holes and the counter support guide holes are mutually aligned in each case.

This offset-free orientation means that the fuselage sections can be drilled through easily in the transverse joint region, without a drilling tool being exposed to shearing forces.

A further advantageous development of the device provides that the support comprises at least one magnet, in particular an electromagnet and/or a permanent magnet.

The magnets make possible contact-free and hole-free fixing in position of the fuselage sections orientated relative to one another, preventing drilling chips from entering between the skins in the transverse joint region and making reseparation of the already positioned fuselage sections to remove the drilling chips unnecessary. A material thickness of the fuselage sections and a thickness of a transverse joint strap in the case of a joint connection of the two skins form a gap for the magnetic circuit formed from respectively opposingly arranged supports and counter supports, and this gap has to be bridged by the magnetic field of the magnets, while taking into account a considerable scatter field. This is because the skins and the transverse joint strap are generally formed with a non-magnetic or paramagnetic aluminium alloy material. The sum of the material thicknesses of these components may be up to 10 mm in the transverse joint region of the fuselage sections, in such a way that the magnets have to generate a high field strength so as still to be able to produce a sufficiently high gripping force for skins having a high material strength and optional transverse joint straps. The magnets are preferably formed as electromagnets so as to facilitate the removal thereof by turning off the current once the drilling and riveting wok in the transverse joint region is complete. Permanent magnets by contrast have the advantage that no expensive electric power supply via high-cross-section cables is required. However, supports comprising permanent magnets and the counter supports arranged opposite can generally only be removed from the transverse joint region using a high force because of the extremely high magnetic field strengths emanating from the permanent magnets. Preferably, the supports each comprise at least one magnet, whilst the counter supports are merely formed from a ferromagnetic material, which has as high a μᵣ value as possible (up to 180,000) to increase the magnetic flux density, so as to reduce the resistance of the magnetic circuit formed by the supports and counter supports.

To generate higher attractive forces, it may be necessary to provide the support and the counter support in the clamping members with magnets of respectively opposite polarity. This has the disadvantage, in particular if electromagnets are used, that the electric supply lines for the electromagnets, which have to have large conductive cross-sections because of the high magnetic field strengths to be produced, have to be guided in the internal space as well as in the external space of the sections to be joined.

The magnets in the gripping members, irrespective of the technical configuration thereof as a permanent magnet or as an electromagnet, are of such a size that a force of at least 150 N acts between a support and a counter support of each gripping element. This results in sufficiently slip-proof fixing in position of the fuselage sections and moreover sufficiently high contact pressure between the skins of the fuselage sections so as to prevent drilling chips from penetrating between the skins in the transverse joint region.

Further advantageous configurations of the device are described in the further claims.

### BRIEF DESCRIPTION OF THE DRAWINGS

In the drawings:

FIG. 1 is a schematic sectional view through a first variant embodiment of a gripping member of the device, having an external support and an internal counter support,

FIG. 2 is a basic cross-sectional view through a second variant embodiment of a gripping member of the device, having an internal support and an external counter support,

FIG. 3 shows a first variant embodiment of the device, having only one circularly applicable gripping member, and

FIG. 4 shows a second variant embodiment of the device, having a plurality of gripping members applied simultaneously and evenly distributed over the periphery of the transverse joint region.

### DESCRIPTION OF EXEMPLARY EMBODIMENTS

In the drawings, like constructional elements have like reference numerals in each case.

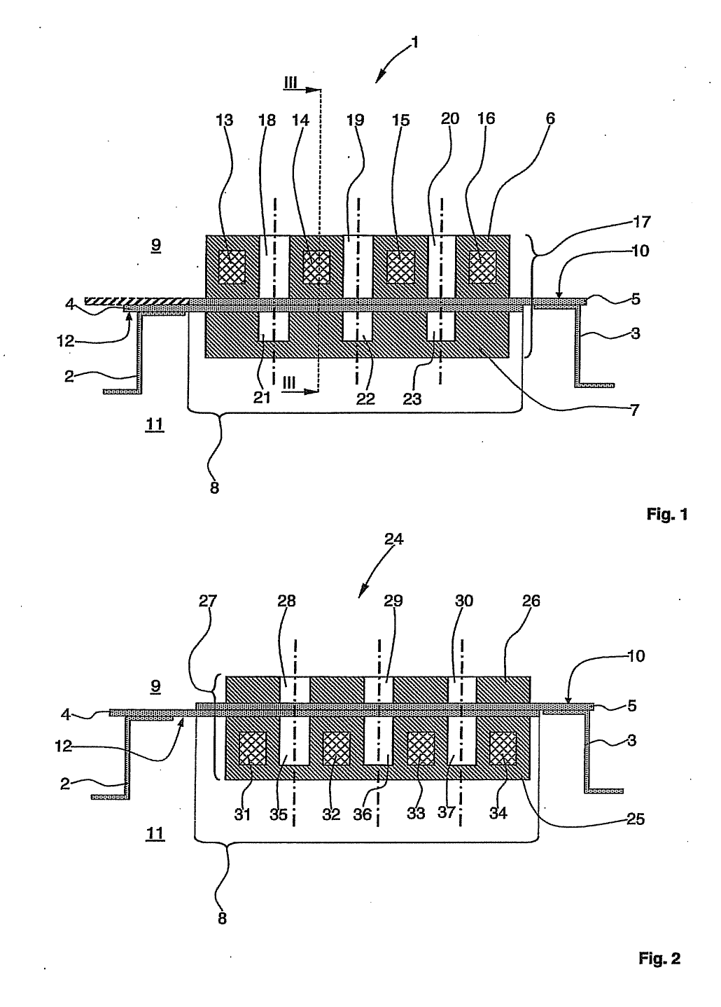

FIG. 1 is a schematic sectional view through a gripping member of the device according to the invention.

A device 1 for fixing in position two fuselage sections 2, 3 to be joined, which are each planked with a skin 4, 5, comprises inter alia a support 6 and a counter support 7. The skins 4, 5, arranged overlapping in a transverse joint region 8, of the fuselage sections 2, 3 are to be joined by connecting members, for example in the form of rivets or bolts. These connecting members are shown by the dot-dash lines. The support 6 is positioned in an external region 9, i.e. in the region of an outer face 10 of the second skin 5, whilst the counter support 7 is positioned opposing the support 6 in so far as possible in an internal region 11 of the fuselage sections 2, 3, i.e. in the region of an inner face 12 of the first skin 4. The orientation of the support 6 and the counter support 7 is provided by in particular optical markings (not shown) which are applied in advance in the region of the fuselage sections 4, 5 to be joined.

The device 1 can correspondingly be used when, unlike in the drawing of FIG. 2, the skins 4, 5 of the two fuselage sections 2, 3 are arranged abutting one another instead of overlapping and are joined by an additional internal transverse joint strap, since even in an arrangement of this type, a total material thickness (skin and transverse joint strap) to be bridged by the support 6 and counter support 7 is no greater than the resulting total material thickness of two skins 4, 5 joined so as to overlap. In this case, an internal transverse joint strap is connected to both end regions of the skins 4, 5. In the drawing of FIG. 1, in an arrangement of this type the transverse joint strap corresponds to the previous first skin 4, whilst the hatched rectangle having an outline drawn in dashes represents the first skin in this case. However, a transverse joint strap would preferably extend centrally relative to the transverse joint region.

In the embodiment shown, the support 6 is provided with four magnets 13 to 16. In the embodiment shown, the counter support 7 is formed in one piece with a preferably ferromagnetic material, but in an alternative embodiment, it may also be provided with a number of magnets corresponding to the number of magnets 13 to 16 provided in the support 6. Ultimately, the support 6 forms, in conjunction with the counter support 7 of the device 1, a magnetic gripping member 17 which during the joining process presses the skins 4, 5 of the two fuselage sections 2, 3 firmly against one another, and thus fixes them, without holes, using the force exerted by a magnetic field. The magnetic gripping member 17 also prevents drilling chips from entering the transverse joint region 8 between the skins 4, 5, in such a way that time-consuming intermediate processing steps for removing the drilling chips can be omitted.

The four magnets 13 to 16 may be configured as permanent magnets or with electromagnets. Alternatively, it is also conceivable to use permanent magnets and electromagnets simultaneously. Particular advantages of permanent magnets are the high magnetic field strength which can be achieved relative to the constructional volume, and the fact that a power supply is not necessary, whilst the primary advantage of using electromagnets is that the magnetic gripping member 17 can easily be removed from the fuselage sections 2, 3 simply by switching off the supply current, and moreover, the gripping member 17 can be aligned more easily when there is no current.

The support 6 further comprises three continuous support guide holes 18 to 20, with which the spatial position, in the skins 4, 5, of the holes required for the connecting members can be established to a high precision. Moreover, the support guide holes 18 to 20 form a guide or a drilling template for a drilling tool (not shown) or a drill, which is used to make the holes required in the transverse joint region 8. Corresponding to the support guide holes 18 to 20, the counter support 7 has three counter support guide holes 21 to 23, optionally continuous in the embodiment shown, making it possible to drill through the skins 4, 5 completely and moreover preventing drilling chips from falling into the internal region 11 of the fuselage sections 2, 3. Alternatively (not shown), the counter support guide holes 21 to 23 may also be formed as blind holes. The support guide holes 18 to 20 and the counter support guide holes 21 to 23 of the gripping member 17 are preferably mutually aligned in each case as a result of the opposing arrangement of the support 6 and the counter support 7, so as to prevent shearing or jamming of the drilling tool during the drilling process.

FIG. 2 is a cross-sectional drawing of a second variant embodiment of the device according to the invention.

The two fuselage sections 2, 3 having the skins 4, 5 are aligned relative to one another in the transverse joint region in such a way that making a corresponding number of holes can be followed by joining the fuselage sections 2, 3 by riveting and/or bolting.

Unlike the variant illustrated in FIG. 1, although this device 24 also has a support 25 and a counter support 26, the counter support 26 is arranged on the outer face 10 of the second skin 5 in the external region 9 of the fuselage sections 2, 3, whilst the (active) support 25 is positioned on the inner face 12 of the first skin 4 in the internal region 11 of the fuselage sections 2, 3. The support 25 and the counter support 26 in turn form a gripping member 27 for fixing the fuselage sections 2, 3 in position in the respective working region. The counter support 26 has three continuous counter support guide holes 28 to 30 and is preferably formed with a ferromagnetic material so as to keep the magnetic resistance low. The support 25 is in turn provided with four magnets 31 to 34, but may alternatively have any desired number of magnets. The magnets 31 to 34, embedded in the support 25 on all sides, can be formed with electromagnets and/or permanent magnets. The support 25 is preferably likewise formed in one piece with a ferromagnetic material. Three support guide holes 35 to 37 are further made in the housing, preferably formed in one piece, of the support 25, and are formed as blind holes. Alternatively, the support guide holes 35 to 37 may also be formed as continuous holes. The counter support guide holes 28 to 30 of the counter support 26 and the support guide holes 35 to 37 of the support 25 are arranged aligned with one another so as to prevent shearing of a drilling tool (not shown). If electromagnets are used, the arrangement according to FIG. 1 may be advantageous, since an external supply of the electrical power cable to the electromagnets integrated into the support 6 is possible irrespective of any electrical and hydraulic systems already present in the fuselage sections. On the other hand, if the support 6 is arranged internally, there may be better accessibility for laying the power cables under some circumstances, since no separate external assembly platform is required.

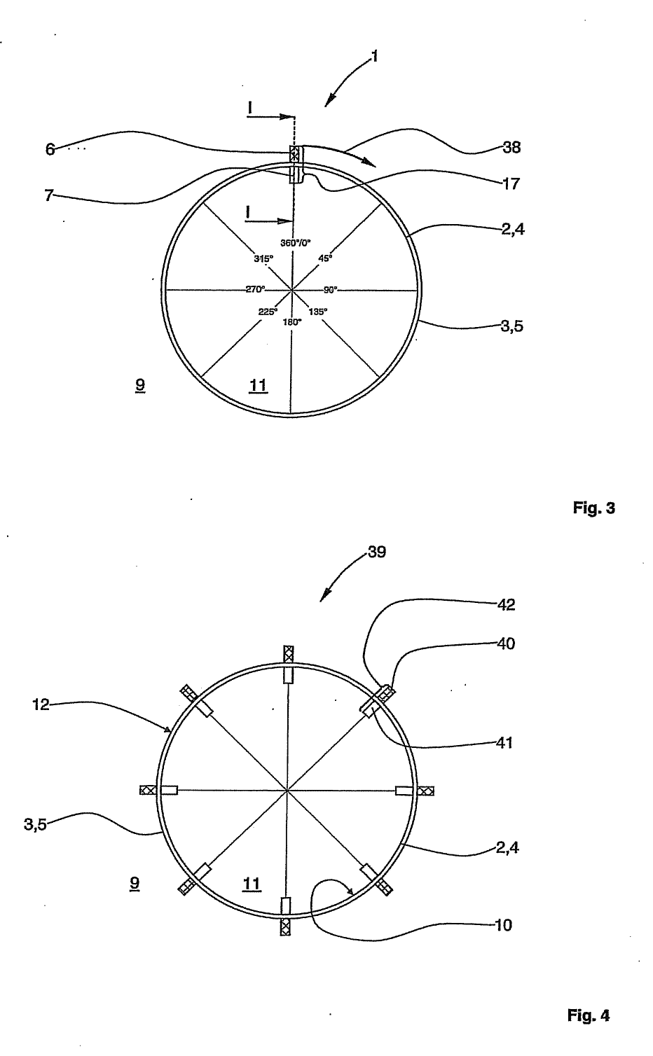

FIG. 3 illustrates the spatial positioning of the device 1 in relation to the fuselage sections 2, 3 or skins 4, 5 by way of a section through the device 1 of FIG. 1 along the section line III-III.

The active support 6 having the strong magnets located therein is placed on the fuselage sections 2, 3 to be joined in the external region, whilst the passive counter support 7 is placed in the internal region 11. The support 6 and the counter support 7 in turn form the gripping member 17 (cf. FIG. 1). Because of the strong magnetic force prevailing between the support 6 and the counter support 7, the skins 4, 5 of the fuselage sections 2, 3 are pressed firmly together, in such a way that the holes necessary for the joining process can be positioned without the risk of chips penetrating between the skins 4, 5. Once the required holes are positioned, the device 1 is displaced for example through an angle of 45° in the direction of a black arrow 38, in such a way that the required holes can also be made in this region. This process is repeated until the transverse seam between the fuselage sections 2, 3 is completely finished. The advantage of this approach is in particular that the device 1 merely requires a support 6 and a counter support 7, and the successive circular displacement of the device 1 prevents local undulation or folding of the skins 4, 5. However, a drawback of the device 1 is that repeated displacement of the device 1 around the periphery of the fuselage sections 2, 3 is always required for producing the transverse seam in the transverse joint region 8, increasing the expenditure of labour. Several hundred holes, into which the connecting members such as bolts or rivets are inserted, are generally necessary to connect or join the fuselage sections 2, 3 completely.

FIG. 4 shows a further variant embodiment of a device according to the invention.

In the embodiment shown, a device 39 comprises a total of eight supports, positioned in the external region 9, and eight counter supports, arranged in the internal region so as to oppose the supports, which together form a gripping member in each case. One support 40 and one counter support 41, which together form a gripping member 42, are provided with a reference numeral as representative of all of the others. The number of gripping members 42, which are arranged over the periphery in the transverse joint region or in the transverse seam region, preferably evenly in relation to one another, is increased to up to 128 as a function of the cross-sectional dimensions of the fuselage sections 2, 3 to be joined, so as to achieve as even a gripping effect as possible.

The device 39 makes it possible to fix the fuselage sections 2, 3 or the skins 4, 5 in the desired assembly position in the transverse seam region over the entire periphery thereof, in such a way that in principle all of the holes required for the joining process by riveting and/or bolting can be made simultaneously, or at least simultaneously in a plurality of peripheral sectors of the fuselage sections 2, 3, the penetration of chips between the skins 4, 5 also being reliably prevented. This means that after a successful joining process further intermediate manufacturing steps, such as the subsequent removal of drilling chips, can be omitted.

A primary advantage of the device 39 is above all that work can be carried out simultaneously in the joint region between the fuselage sections 2, 3, reducing the assembly times considerably. However, as a result of the simultaneous gripping, fold formation or deformation is prevented in the skins 4, 5.

### LIST OF REFERENCE NUMERALS

1 device
2 first fuselage section
3 second fuselage section
4 first skin (first fuselage section/transverse joint strap)
5 second skin (second fuselage section)
6 support
7 counter support
8 transverse joint region
9 external region (fuselage sections)
10 outer face (second skin)
11 internal region (fuselage sections)
12 inner face (first skin)
13 magnet
14 magnet
15 magnet
16 magnet
17 gripping member
18 support guide hole
19 support guide hole
20 support guide hole
21 counter support guide hole
22 counter support guide hole
23 counter support guide hole
24 device
25 support
26 counter support
27 gripping member
28 counter support guide hole
29 counter support guide hole
30 counter support guide hole
31 magnet
32 magnet
33 magnet
34 magnet
36 support guide hole
36 support guide hole
37 support guide hole
38 arrow
39 device
40 support
41 counter support
42 gripping member

1. A device for fixing in position a first fuselage section in a transverse joint region and a second fuselage section to be joined, the first fuselage section being planked with a first skin and the second fuselage section being planked with a second skin, it being possible for the fuselage sections to be connected temporarily by at least one gripping member in the transverse joint region, the gripping members each comprising a support and a counter support, wherein the at least one support comprises a plurality of support guide holes and the at least one counter support comprises a plurality of counter support guide holes corresponding to the plurality of support guide holes for exactly determining the position of holes to be made in the transverse joint region.

2. The device according to claim 1, wherein a plurality of gripping members are provided, and can be positioned over the periphery in the transverse joint region, in particular evenly mutually spaced.

3. The device according to claim 1, wherein the plurality of support guide holes and the plurality of counter support guide holes are mutually aligned in each case.

4. The device according to claim 1, wherein the at least one support comprises at least one magnet, in particular an electromagnet and/or a permanent magnet.

5. The device according to claim 1, wherein the at least one counter support is formed with a ferromagnetic material and/or comprises a magnet, in particular an electromagnet and/or a permanent magnet.

6. The device according to claim 1, wherein a magnetic attractive force of up to 300 N in each case can be exerted between the at least one support and the at least one counter support through the two skins of the fuselage sections to be joined.

7. The device according to claim 1, wherein the at least one support in the region of an outer face of the second skin and the at least one counter support in the region of an inner face of the first skin, can be arranged opposing one another in each case in the transverse joint region.

8. The device according to claim 1, wherein the at least one support in the region of an inner face of the first skin and the at least one counter support in the region of an outer face of the second skin can be arranged opposing one another in each case in the transverse joint region.

9. The device according to claim 1, wherein a material thickness of the two skins and that of a transverse joint strap are each up to 5 mm.
